(19) United States
(12) Patent Application Publication
(10) Pub. No.: US 2010/0161665 A1
(43) Pub. Date: Jun. 24, 2010

(54) INFORMATION PROCESSING APPARATUS, INFORMATION PROCESSING SYSTEM AND COMPUTER READABLE MEDIUM

(75) Inventor: Kazuteru DAIMON, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/482,612

(22) Filed: Jun. 11, 2009

(30) Foreign Application Priority Data
Dec. 19, 2008 (JP) 2008-324117

(51) Int. Cl. G06F 17/30

(52) U.S. Cl. 707/783; 707/E17.01

(57) ABSTRACT

A computer readable medium storing a program causing a computer to execute a process for managing accesses, the process includes: causing a user information storage unit to store user information; accepting authorized user information indicating an authorized user as a user permitted to execute a predetermined process on target information; issuing an instruction for storing a duplicate of target information in an information management apparatus associated with the authorized user, when the authorized user is not included in users shown by user information associated with the information management apparatus storing therein the target information; and issuing a instruction to the information management apparatus storing therein the duplicate of the target information to perform setting so that the information management apparatus can execute the predetermined process on the duplicate of the target information based on the authorized user's request.

### CROSS-REFERENCE TO RELATED APPLICATIONS

This application is based on and claims priority under 35 USC 119 from Japanese Patent Application No. 2008-324117 filed Dec. 19, 2008.

### BACKGROUND

1. Technical Field

The present invention relates to an information processing apparatus, an information processing system and a computer readable medium.

2. Related Art

There is an information processing system in which an information management apparatus such as a file server or a schedule management server corresponding to each group is provided to permit limited users each belonging to the corresponding group to execute a process such as a read process or an update process on information (e.g. document information or schedule information) stored in the information management apparatus.

There have been already some techniques concerned with such an information processing system in which a user who does not belong to a group corresponding to a certain one of information management apparatuses can make use of information stored in the information management apparatus.

### SUMMARY

According to an aspect of the invention, a computer readable medium storing a program causing a computer to execute a process for managing accesses, the process includes: causing a user information storage unit to store user information indicating users in association with at least one of information management apparatuses; accepting authorized user information indicating an authorized user as a user permitted to execute a predetermined process on target information (i) which has been stored in one of the information management apparatuses and (ii) which is a target to be subjected to the predetermined process; issuing an first instruction for storing a duplicate of the target information in an information management apparatus associated with the user information indicating the authorized user, when the authorized user is not included in users shown by user information associated with the information management apparatus storing therein the target information; and issuing a second instruction to the information management apparatus storing therein the duplicate of the target information to perform setting so that when the information management apparatus accepts a request for executing the predetermined process on the duplicate of the target information from the authorized user, the information management apparatus can execute the predetermined process on the duplicate of the target information.

### BRIEF DESCRIPTION OF THE DRAWINGS

Exemplary embodiment(s) of the present invention will be described in detail based on the following figures, wherein:

FIG. 1 is a view showing an example of a network configuration of an information processing system according to an exemplary embodiment of the invention;

FIG. 2 is a view showing an example of a hardware configuration of an information processing apparatus according to an exemplary embodiment of the invention;

FIG. 3 is a functional block diagram showing a functional example achieved by the information processing system according to an exemplary embodiment of the invention;

FIG. 4 is a table showing an example of user information;

FIG. 5 is a table showing an example of folder correspondence information;

FIG. 6 is a table showing an example of file synchronization information; and

FIG. 7 is a flow chart showing an example of a processing flow performed by the information processing system according to the exemplary embodiment.

### DETAILED DESCRIPTION

An exemplary embodiment of the invention will be described below in detail with reference to the drawings.

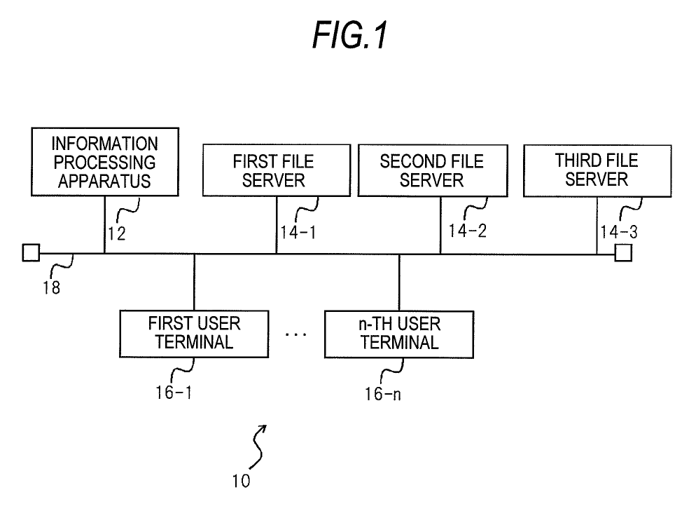

As shown in FIG. 1 which is a network configuration view, an information processing system 10 in the exemplary embodiment includes an information processing apparatus 12, information management apparatuses (e.g. file servers 14 (first to third file servers 14-1 to 14-3) in the exemplary embodiment), and user terminals (clients) 16 (e.g. first to n-th user terminals 16-1 to 16-n in the exemplary embodiment). The information processing apparatus 12, the file servers 14 and the user terminals 16 are connected to a network 18 such as the Internet so as to communicate with each other through the network 18. Incidentally, each information management apparatus is not limited to the file server 14. For example, the information management apparatus may be a schedule management server.

For example, each file server 14 shown in FIG. 1 has a control device such as a CPU, a storage device such as a hard disk, a communication device such as a network board, etc.

For example, each user terminal 16 shown in FIG. 1 is constituted by a known personal computer including a control device such as a CPU, a storage device such as a hard disk, an output device such as a display, input devices such as a keyboard and a mouse, and a communication device such as a network board.

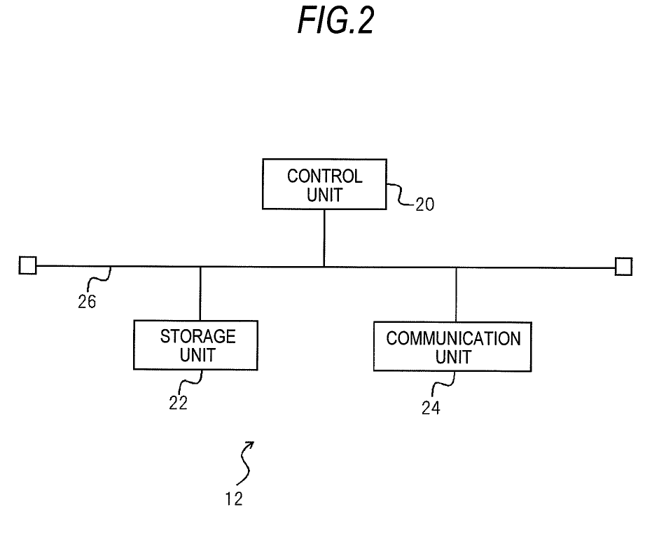

FIG. 2 is a view showing an example of a hardware configuration of the information processing apparatus 12 in the exemplary embodiment. As shown in FIG. 2, the information processing apparatus 12 in the exemplary embodiment includes a control unit 20, a storage unit 22 and a communication unit 24. These elements are connected to each other through a bus 26.

The control unit 20 is a program control device such as a CPU. The control unit 20 operates in accordance with a program installed in the information processing apparatus 12.

The storage unit 22 is a storage device such as a ROM or a RAM, a hard disk, etc. The program etc. to be executed by the control unit 20 is stored in the storage unit 22. The storage unit 22 also operates as a working memory for the control unit 20.

For example, the communication unit 24 is a communication interface such as a network board. The communication unit 24 exchanges information with each file server 14 and each user terminal 16.

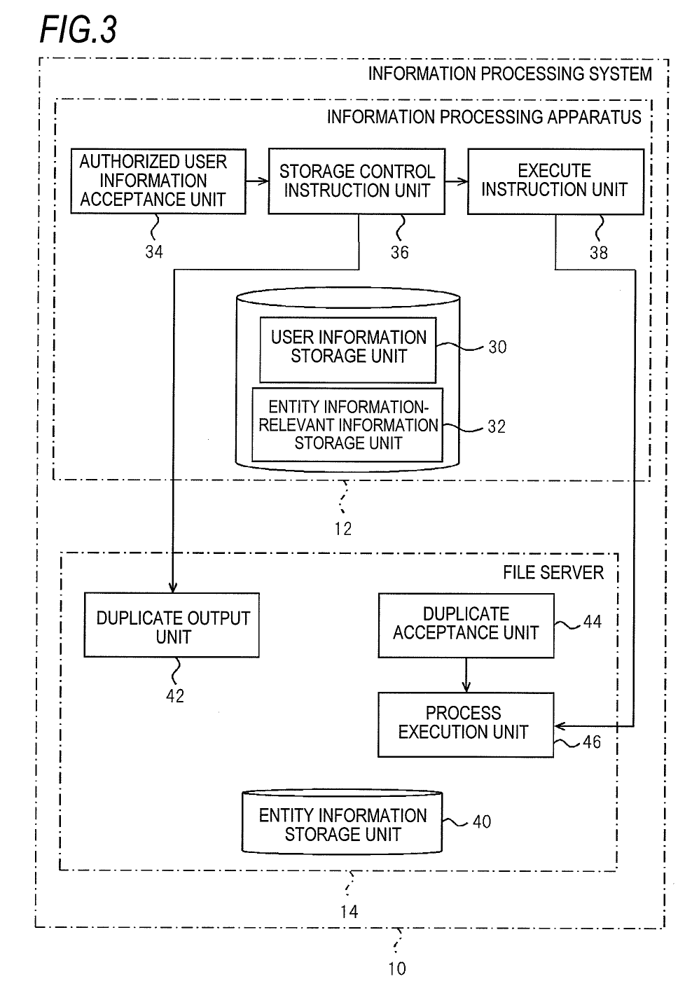

FIG. 3 is a functional block diagram showing a functional example achieved by the information processing system 10 according to the exemplary embodiment.

As shown in FIG. 3, the information processing apparatus 12 serves as an apparatus including a user information storage unit 30, an entity information-relevant information storage unit 32, an authorized user information acceptance unit 34, a storage control instruction unit 36, and an execute instruction unit 38. The user information storage unit 30 and the entity information-relevant information storage unit 32 are chiefly achieved by the storage unit 22 while the other elements are chiefly achieved by the control unit 20.

Each file server 14 serves as an apparatus including an entity information storage unit 40, a duplicate output unit 42, a duplicate acceptance unit 44 and a process execution unit 46. The entity information storage unit 40 is chiefly achieved by the storage device of the file server 14 while the other elements are chiefly achieved by the control device of the file server 14.

These elements are realized by that the control unit 20 of the information processing apparatus 12 and the control device of the file server 14 execute programs installed in the information processing apparatus 12 and the file server 14 which are computers. For example, the programs are supplied to the information processing apparatus 12 and the file server 14 through a computer-readable information transmission medium such as a CD-ROM or a DVD-ROM or through a communication network such as the Internet.

In the exemplary embodiment, the entity information storage unit 40 of the file server 14 stores entity information such as document information about files or folders. Incidentally, the entity information is not limited to document information but may be information associated with information (authorization information) indicating conditions of a user who should be permitted to process the entity information. An example of such entity information is schedule information.

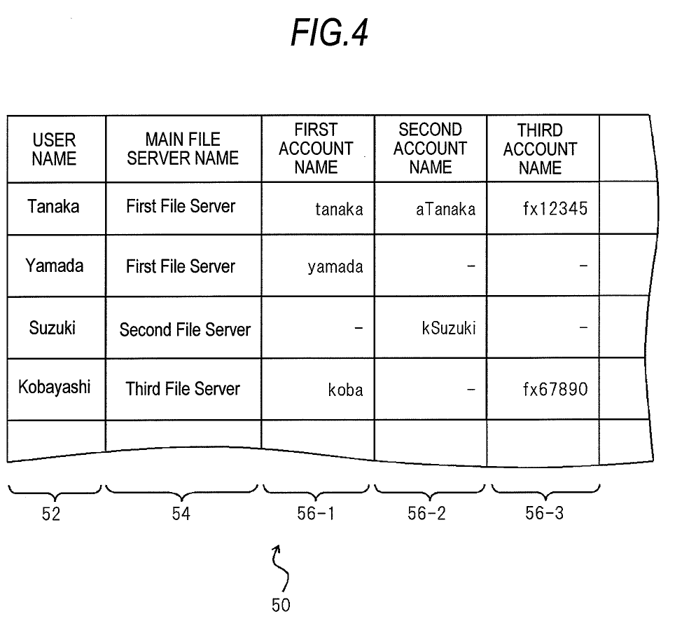

The user information storage unit 30 of the information processing apparatus 12 stores user information 50 indicating users as shown in FIG. 4. In the exemplary embodiment, for example, each piece of the user information 50 includes a user name 52 indicating the name of a user, a main file server name 54 indicating the name of a file server 14 (e.g. a file server 14 the user usually uses) associated with the user, and account names 56 (first to third account names 56-1 to 56-3) indicating names of accounts in each file server 14. The user information 50 may be associated with a plurality of file servers 14. For example, the main file server name 54 may indicate the name of a file server product.

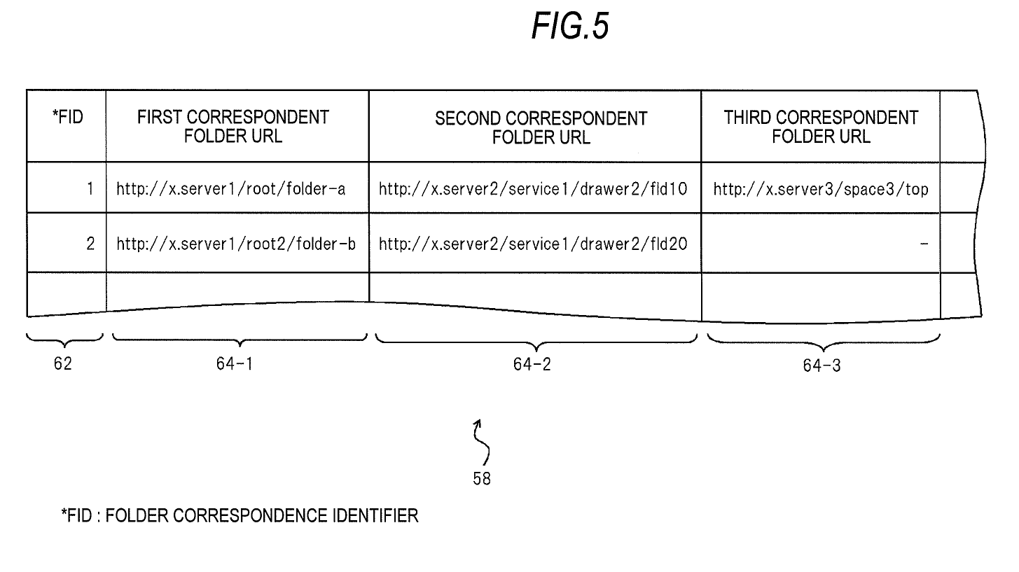

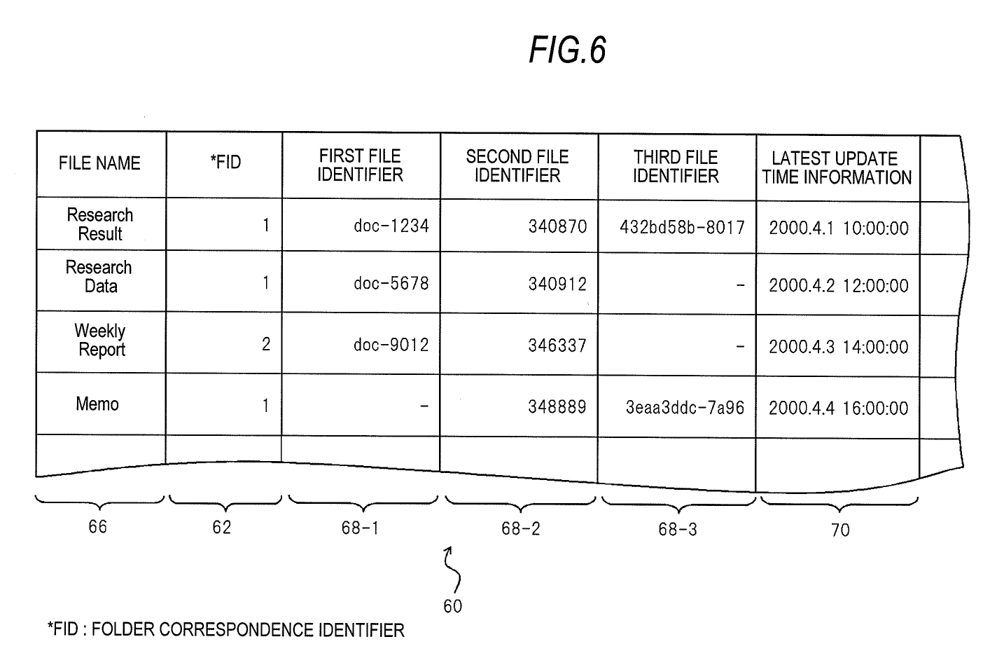

In the exemplary embodiment, for example, the entity information-relevant information storage unit 32 of the information processing apparatus 12 stores folder correspondence information 58 as shown in FIG. 5 and file synchronization information 60 as shown in FIG. 6.

For example, the folder correspondence information 58 is information (e.g. paths or URLs) etc. indicating folders corresponding to one another among the file servers 14. In the exemplary embodiment, for example, each piece of the folder correspondence information 58 includes a folder correspondence identifier 62 which is an identifier of the piece of the folder correspondence information 58, and correspondent folder URLs 64 (first to third correspondent folder URLs 64-1 to 64-3) indicating URLs of correspondent folders of the respective file servers 14.

The file synchronization information 60 is information indicating the relation of files synchronized among the file servers 14. Each piece of the file synchronization information 60 includes a file name 66 indicating the name of a file synchronized among the file servers 14, a folder correspondence identifier 62 corresponding to folders where the synchronized file is stored, file identifiers 68 (first to third file identifiers 68-1 to 68-3) which are identifiers given to the synchronized file by the respective file servers 14, and latest update time information 70 indicating a latest update time of the file.

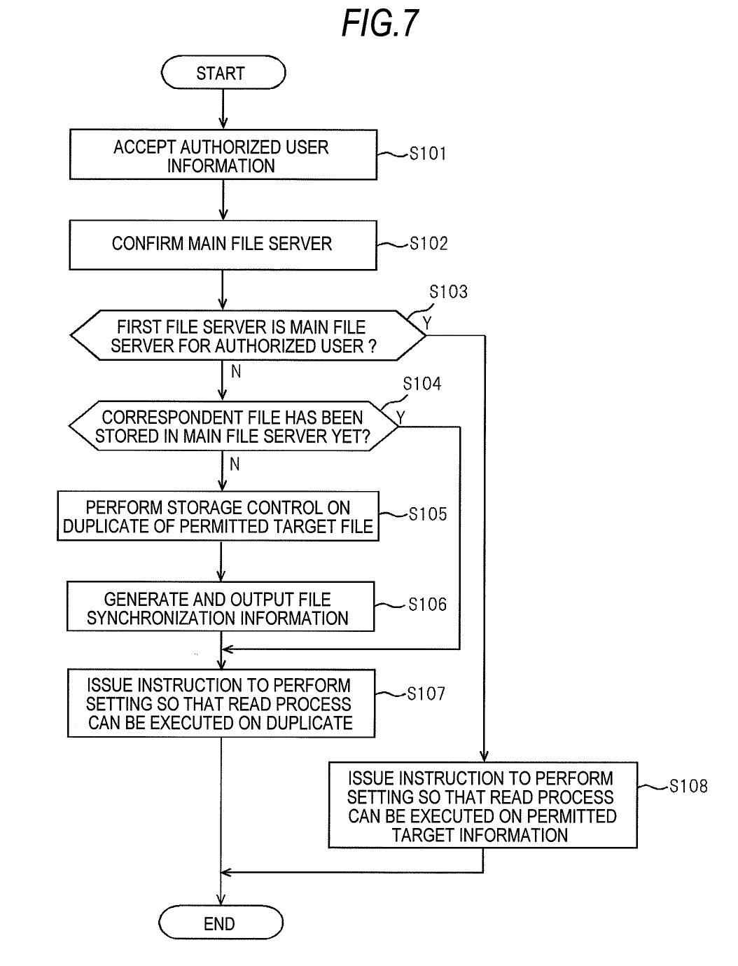

Here, an example of a processing flow performed by the information processing system 10 according to the exemplary embodiment will be described with reference to a flow chart shown in FIG. 7. In this processing example, target information (e.g. a target file in the processing example) as a target to be subjected to a process (e.g. a read process) predetermined for each user has been stored in the entity information storage unit 40 of the first file server 14-1. Incidentally, the first file server 14-1 may accept a target file outputted from a user terminal 16 and store the target file in the entity information storage unit 40. The read process in this processing example is nothing but an example of the aforementioned predetermined process. The predetermined process is not limited particularly as long as it is a process which can be executed on target information in accordance with a request from a user. For example, the predetermined process may be an update process or a delete process.

First, the authorized user information acceptance unit 34 accepts authorized user information indicating an authorized user who is permitted to execute a read process on a target file (S101). Specifically, the authorized user information acceptance unit 34 accepts location information (e.g. a path or a URL) indicating the location of the target file in the first file server 14-1 and a user name 52 indicating the authorized user. Alternatively, the authorized user information acceptance unit 34 may accept authorized user information indicating a plurality of authorized users. Alternatively, the authorized user information acceptance unit 34 may accept authorized user information indicating an authorized user permitted to execute a read process on a plurality of target files (e.g. a file group in a target folder).

The storage control instruction unit 36 confirms a file server 14 (hereinafter referred to as main file server) with which the authorized user accepted by the step S101 is associated (S102). Specifically, for example, the storage control instruction unit 36 acquires a main file server name 54 associated with the user name 52 corresponding to the authorized user by referring to the user information 50, so that the main file server is confirmed.

The storage control instruction unit 36 checks whether the authorized user is included in users shown by the user information 50 associated with the file server 14 (the first file server 14-1 in this processing example) having stored therein the target file or not (i.e. whether the file server 14 is the main file server of the authorized user or not) (S103). Specifically, for example, the storage control instruction unit 36 checks whether the main file server name 54 acquired by the step S102 indicates the first file server 14-1 or not.

When the authorized user is not included in users shown by the user information 50 (No in S103), the storage control instruction unit 36 checks whether a correspondent file which is a file (e.g. a duplicate of the target file etc.) corresponding to the target file has been stored in the entity information storage unit 40 of the main file server or not (S104).

When the correspondent file has not been stored in the entity information storage unit 40 of the main file server (No in S104), the storage control instruction unit 36 issues an instruction to (i.e. performs storage control on) the entity information storage unit 40 of the main file server to store a duplicate of the target file (S105). Specifically, for example, the storage control instruction unit 36 issues an instruction to the first file server 14-1 to output a duplicate of the target file to the main file server. In this case, for example, the duplicate output unit 42 of the first file server 14-1 then generates a duplicate of the target file and outputs the duplicate to the main file server. On accepting the duplicate, the duplicate acceptance unit 44 of the main file server outputs the duplicate to the entity information storage unit 40 of the main file server.

In the aforementioned case, it is a matter of course that the storage control instruction unit 36 may issue an instruction to the first file server 14-1 to output a duplicate of the target file to the information processing apparatus 12. The duplicate output unit 42 of the first file server 14-1 may generate a duplicate of the target file and output the duplicate to the information processing apparatus 12. On accepting the duplicate, the storage control instruction unit 36 of the information processing apparatus 12 may output the duplicate to the main file server.

Incidentally, the storage control instruction unit 36 may be designed to output the duplicate of the target file to a folder of the main file server corresponding to a folder of the first file server 14-1 in which the target file has been stored, based on the folder correspondence information 58.

The storage control instruction unit 36 generates file synchronization information 60 indicating the relation between the target file and the duplicate of the target file and outputs the file synchronization information 60 to the entity information-relevant information storage unit 32 (S106). Specifically, for example, the storage control instruction unit 36 generates file synchronization information 60 including a file name 66 of the target file, a folder correspondence identifier 62 corresponding to folders where the target file is stored, a first file identifier 68-1 given to the target file by the first file server 14-1, a file identifier 68 given to the duplicate of the target file by the main file server and latest update time information 70 indicating a latest update time of the target file, and outputs the file synchronization information 60 to the entity information-relevant information storage unit 32.

After the step S106 has been completed or in the case where it has been confirmed in the step S104 that the correspondent file has been stored in the entity information storage unit 40 of the main file server (Yes in S104), the execute instruction unit 38 issues an instruction to the main file server to perform setting so that the main file server can execute a read process on the duplicate of the target file when the main file server accepts a request for executing the read process on the duplicate of the target file from the authorized user (S107). Specifically, for example, the execute instruction unit 38 updates information which is associated with the duplicate of the target file and indicates conditions of the user who should be permitted to execute the read process. Thus, the authorized user is permitted to execute the read process on the duplicate of the target file. More specifically, for example, the execute instruction unit 38 executes a process for setting a right for the authorized user to read the duplicate of the target file (e.g. a process for adding an ACE granting a read right to the authorized user to an ACL associated with the target file). It is a matter of course that the main file server may accept an instruction for setting a read right from the execute instruction unit 38 and execute a process for setting a right for the authorized user to read the duplicate of the target file.

In the case where it has been confirmed in the step S103 that the authorized user is included in users shown by the user information 50 associated with the first file server 14-1 (Yes in S103), the execute instruction unit 38 issues an instruction to the first file server 14-1 to perform setting so that the main file server can execute a read process on the target file when the main file server accepts of a request for executing the read process on the target file from the authorized user (S108) Specifically, for example, in the same manner as in the aforementioned process, the execute instruction unit 38 executes a process etc. for updating information which is associated with the target file and indicates conditions of the user who should be permitted to execute the read process. Thus, the authorized user is permitted to execute the read process on the target file.

Incidentally, a plurality of pieces of authorized user information may be acquired in the step S101. In this case, the steps S102 to S108 are executed repetitively on the respective pieces of the authorized user information.

Here, a specific example of the aforementioned processing example will be described. The user information 50 shown in FIG. 4 is stored in the user information storage unit 30. A user “Tanaka” has sent a request to the information processing apparatus 12 for permission for a user “Yamada”, a user “Suzuki” and a user “Kobayashi” to perform a read process on a target file whose file name 66 is “research result” and which has been stored in the entity information storage unit 40 of the first file server 14-1.

In this case, by the process shown in the aforementioned processing example, setting is done as follows. That is, the main file server name 54 for the user “Yamada” included in the user information 50 is the first file server 14-1. Therefore, a right to read the target file stored in the first file server 14-1 is set for the user “Yamada”. The main file server name 54 for the user “Suzuki” included in the user information 50 is the second file server 14-2. Therefore, a right to read a duplicate of the target file stored in the second file server 14-2 is set for the user “Suzuki”. The main file server name 54 for the user “Kobayashi” included in the user information 50 is the third file server 14-3. Therefore, a right to read a duplicate of the target file stored in the third file server 14-3 is set for the user “Kobayashi”.

In this case, assume that a request for reading the target file which request is associated with the user “Yamada” is sent from a user terminal 16 to the first file server 14-1. Then, the process execution unit 46 of the first file server 14-1 outputs the target file to the user terminal 16. Similarly, assume that a request for reading the target file which request is associated with the user “Suzuki” (or the user “Kobayashi”) is sent from a user terminal 16 to the second file server 14-2 (or the third file server 14-3). Then, the process execution unit 46 of the second file server 14-2 (or the third file server 14-3) outputs the duplicate of the target file to the user terminal 16. In this manner, the process execution units 46 of the file servers 14 execute a predetermined process (e.g. a read process) on target information or a duplicate.

Incidentally, assume that the user “Tanaka” has executed a register process of a target file on the second file server 14-2 (that is, the second file server 14-2 accepts a target file outputted from a user terminal 16 based on a request of the user “Tanaka”) and the target file has been stored in the entity information storage unit 40 of the second file server 14-2. Then, the user “Tanaka” may permit the user “Tanaka” himself/herself to perform a read process on the target file. In this case, the main file server name 54 included in the user information 50 for the user “Tanaka” is the first file server 14-1. Therefore, the storage control instruction unit 36 performs storage control on the entity information storage unit 40 of the first file server 14-1 associated with the user “Tanaka” to store a duplicate of the target file.

In this exemplary embodiment, while a process is executed on the target file (or the duplicate), the execute instruction unit 38 issues an instruction to the file server 14 having stored therein the duplicate (or the target file) to execute a process corresponding to the executed process on the duplicate (or the target file).

In the exemplary embodiment, specifically, for example, the execute instruction unit 38 periodically monitors the name or the latest update time of document information of a target file, a duplicate thereof, or the like, stored in the entity information storage unit 40 of each file server 14, or whether the document information is present or not.

When, for example, the first file server 14-1 has updated a target file (or duplicate) in accordance with a request from a user, the execute instruction unit 38 detects the fact that the target file (or duplicate) has been updated, for example, based on the file synchronization information 60. Based on the update contents, the execute instruction unit 38 issues an instruction to the second file server 14-2 and the third file server 14-3 to update the contents of the duplicate (or target file) stored in the entity information storage units 40 (or to duplicate the file) correspondingly to the target file (or duplicate).

When the first file server 14-1 has changed or deleted the name of a target file (or duplicate) in accordance with a user's request, the execute instruction unit 38 issues an instruction to the second file server 14-2 and the third file server 14-3 to change or delete the name of a correspondent file, in the same manner as in the aforementioned process. Incidentally, in the case of deletion, the execute instruction unit 38 also deletes file synchronization information 60 corresponding to the deleted file.

When, for example, the authorized user information acceptance unit 34 has accepted authorized user information for additionally permitting execution of a read process, steps the same as the steps S102 to S108 are executed.

When, for example, the authorized user information acceptance unit 34 accepts a request for changing a process an authorized user is permitted to perform on a target file (or duplicate) or a request for depriving an authorized user of permission to perform a process on a target file (or duplicate), the execute instruction unit 38 issues an instruction to a file server 14 having stored therein the duplicate (or target file), to perform change or deprivation of the permitted process on the duplicate (or target file).

Assume that the user permitted to execute the predetermined process on the file stored in the file server 14 is not anymore included in users shown by the user information 50 associated with the file server 14. Then, the execute instruction unit 38 may issue an instruction to the file server 14 to delete the file (e.g. the target file or duplicate). Assume that there is no user (given a process execution right) permitted to execute the predetermined process on the target file or duplicate (specifically, for example, there is no ACE contained in the ACL associated with the file). Then, the execute instruction unit 38 may issue an instruction to the file server 14 to delete the file (e.g. the target file or duplicate). Incidentally, on this occasion, the execute instruction 38 may also delete the file synchronization information 60 corresponding to the file.

The invention is not limited to the exemplary embodiment.

For example, the user information 50 may include a group name indicating a group to which the user belongs. In the step S103, the storage control instruction unit 36 may check whether or not the file server 14 having stored therein the target file is associated with the group to which the authorized user belongs.

The information processing apparatus 12 may be formed by one housing or may be formed by a plurality of housings. In addition, the information processing apparatus 12 and the file servers 14 may be formed by a common housing. The number of file servers 14 and the number of user terminals 16 contained in the information processing system 10 are not limited particularly.

The specific numerical values and the specific character strings described in the specification are simply illustrated. The invention is not limited to these numerical values and character strings.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for managing accesses, the process comprising:
causing a user information storage unit to store user information indicating users in association with at least one of information management apparatuses;
accepting authorized user information indicating an authorized user as a user permitted to execute a predetermined process on target information (i) which has been stored in one of the information management apparatuses and (ii) which is a target to be subjected to the predetermined process;
issuing an first instruction for storing a duplicate of the target information in an information management apparatus associated with the user information indicating the authorized user, when the authorized user is not included in users shown by user information associated with the information management apparatus storing therein the target information; and
issuing a second instruction to the information management apparatus storing therein the duplicate of the target information to perform setting so that when the information management apparatus accepts a request for executing the predetermined process on the duplicate of the target information from the authorized user, the information management apparatus can execute the predetermined process on the duplicate of the target information.

2. The computer readable medium according to claim 1, wherein
issuing when a first process is executed on one of the target information and the duplicate of the target information, a third instruction to the information management apparatus storing therein the other of the target information and the duplicate of the target information to execute a second process corresponding to the first process on the other of the target information and the duplicate of the target information.

3. The computer readable medium according to claim 1, wherein
issuing when the user permitted to execute the predetermined process on the target information stored in the information management apparatus is not anymore included in the users shown by the user information associated with the information management apparatus, a fourth instruction to the information management apparatus to delete the target information.

4. The computer readable medium according to claim 1, wherein
issuing when accepting the authorized user information indicating one of the users shown by the user information associated with the information management apparatus storing therein the target information, an instruction to the information management apparatus to perform setting so that when the information management apparatus accepts a request for executing the predetermined process on the target information from such one of users by the authorized user information, the information management apparatus can execute the predetermined process on the target information.

5. The computer readable medium according to claim 1, wherein:
the issuing the first instruction comprises:
acquiring the duplicate of the target information from the information management apparatus storing therein the target information; and
outputting the duplicate of the target information to the information management apparatus associated with the authorized user.

6. The computer readable medium according to claim 1, wherein
the issuing the first instruction comprises:
issuing the first instruction to the information management apparatus storing therein the target information to output the duplicate of the target information to the information management apparatus associated with the authorized user.

7. An information processing apparatus comprising:
a user information storage unit that causes a user information storage unit to store user information indicating users in association with at least one of information management apparatuses;
an authorized user information acceptance unit that accepts authorized user information indicating an authorized user as a user permitted to execute a predetermined process on target information (i) which has been stored in one of the information management apparatuses and (ii) which is a target to be subjected to the predetermined process;
a first instruction unit that issues an first instruction for storing a duplicate of the target information in an information management apparatus associated with the user information indicating the authorized user, when the authorized user is not included in users shown by user information associated with the information management apparatus storing therein the target information; and
a second instruction unit that issues a second instruction to the information management apparatus storing therein the duplicate of the target information to perform setting so that when the information management apparatus accepts a request for executing the predetermined process on the duplicate of the target information from the authorized user, the information management apparatus can execute the predetermined process on the duplicate of the target information.

8. An information processing system comprising:
an information processing apparatus;
a first information management apparatus; and
a second information management apparatus, wherein:
the first information management apparatus includes:
a target information storage unit that stores target information as a target to be subjected to a predetermined process in the second information management apparatus; and
a duplicate output unit that outputs a duplicate of the target information,
the second information management apparatus includes:
a duplicate acceptance unit that accepts the duplicate of the target information;
a duplicate storage unit that stores the duplicate of the target information accepted by the duplicate acceptance unit; and
a process execution unit that executes the predetermined process on the duplicate of the target information stored in the duplicate storage unit, and
the information processing apparatus includes:
a user information storage unit that stores user information indicating users in association with at least one of the first and second information management apparatuses;
an authorized user information acceptance unit that accepts authorized user information indicating an authorized user as a user permitted to execute the predetermined process on the target information;
a first instruction unit that issues an first instruction for storing a duplicate of the target information in the second information management apparatus, when the authorized user is not included in users shown by user information associated with the first information management apparatus storing therein the target information; and
a second instruction unit that issues a second instruction to the second information management apparatus to perform setting so that when the second information management apparatus accepts a request for executing the predetermined process on the duplicate of the target information from the authorized user, the second information management apparatus can execute the predetermined process on the duplicate of the target information.
